(19) United States
(12) Patent Application Publication
(10) Pub. No.: US 2016/0347323 A1
(43) Pub. Date: Dec. 1, 2016

(54) DRIVING ASSISTANCE DEVICE AND DRIVING ASSISTANCE METHOD

(71) Applicants: DENSO CORPORATION, Kariya-city (JP); TOYOTA JIDOSHA KABUSHIKI KAISHA, Toyota-shi (JP)

(72) Inventors: Naoto Yoshitomi, Kariya-city (JP); Jian Hu, Kariya-city (JP); Shota Satomura, Kariya-city (JP); Yusuke Fujimaki, Nissin-shi (JP)

(21) Appl. No.: 15/166,640

(22) Filed: May 27, 2016

(30) Foreign Application Priority Data
May 29, 2015 (JP) 2015-110568

(51) Int. Cl. B60W 40/04; B60K 35/00

(52) U.S. Cl. CPC B60W 40/04; B60K 35/00; B60W 2420/42; B60W 2540/20; B60W 2540/18; B60W 2520/14; B60W 2420/52; B60K 2350/1096

(57) ABSTRACT

A traffic sign detection section in an ECU detects a ramp sign in front image data captured by an in-vehicle camera. The ramp sign includes an exit symbol and a speed limit symbol. The exit symbol provides an indication of a place where the own vehicle leaves a current driving lane and enters a ramp lane connected to the current driving lane. A distance detection section detects a width distance between the own vehicle and the ramp sign. A driver's intention detection section detects driver's intention to change a current driving lane to a ramp lane. A lane entry detection section detects that the own vehicle enters the ramp lane when the distance detected by the distance detection section is smaller than a predetermined distance, a direction to change the current driving lane detected by the driver's intention detection section is equal to a direction designated by the exit symbol in the ramp sign.

### CROSS-REFERENCE TO RELATED APPLICATION

This application is related to and claims priority from Japanese Patent Application No. 2015-110568 filed on May 29, 2015, the contents of which are hereby incorporated by reference.

### BACKGROUND OF THE INVENTION

1. Field of the Invention

The present invention relates to driving assistance devices and methods capable of detecting the presence of a ramp lane connected to a driving lane or vehicle lane on a highway on which a vehicle travels.

2. Description of the Related Art

Recently, there have been proposed driving assistance devices capable of performing driving assistance for the driver of a vehicle. For example, a conventional driving assistance device detects a ramp lane as a connection lane connected to a driving lane on a highway (a vehicle roadway) on which the vehicle travels.

A patent document, Japanese patent laid open publication No. JP 2008-189093 discloses a conventional vehicle driving control device capable of detecting the presence of a ramp lane as a connection lane which is connected to a driving lane on the highway on the basis of navigation information transmitted from a vehicle navigation system. The vehicle navigation system is mounted on the vehicle. The vehicle driving control device detects that the own vehicle has entered into a ramp lane as the connection lane connected to a driving lane on a highway when:

(a) detecting the presence of a ramp lane as a connection lane;

(b) detecting or estimating occurrence of a driver's request to change a current driving lane on a highway; and

(c) detecting that the own vehicle crosses a dotted lane boundary line which divides the current driving lane from the ramp lane.

When a highway has multiple driving lanes, including a ramp lane, a plurality of the driving lanes are divided from each other by dotted boundary lines as traffic markers or symbols, and there is a possible incorrect detection by the conventional vehicle driving control device, disclosed in the patent document previously described, which detects that the own vehicle travels on the current driving lane on the highway, and enters the ramp lane when the own vehicle crosses a dotted boundary line which separates the current driving lane from another driving lane, not a ramp lane.

In addition to the possible incorrect detection previously described, because the conventional vehicle driving control device performs the driving assistance on the basis of navigation information transmitted from the vehicle navigation system, it is difficult to apply the vehicle driving control device to vehicles on which no vehicle navigation system is mounted.

### SUMMARY

It is therefore desired to provide a driving assistance device capable of correctly and effectively detecting entry of an own vehicle into a ramp lane as a connection lane connected to a driving lane on a vehicle roadway such as a highway on which the vehicle travels.

An exemplary embodiment provides a driving assistance device having a traffic sign detection section, a distance detection section, a driver's intention detection section and a lane entry detection section.

The traffic sign detection section detects a ramp sign. The ramp sign includes an exit symbol and a speed limit symbol on a basis of front image data captured by an in-vehicle camera mounted on an own vehicle. The exit symbol calls the attention of the driver of the own vehicle to leave a driving lane on a vehicle roadway such as a highway and enter a connection lane such as a ramp lane connected to the driving lane.

The distance detection section detects a distance in a width direction of the vehicle roadway between the own vehicle and the ramp sign detected by the traffic sign detection section.

The driver's intention detection section detects driver's intention for the own vehicle to change a current driving lane of the own vehicle.

The lane entry detection section detects that the own vehicle enters the connection lane, i.e. the ramp lane when the distance detected by the distance detection section is smaller than a predetermined distance, a direction to change the current driving lane of the own vehicle detected by the driver's intention detection section is equal to a direction designated by the exit symbol in the ramp sign.

In the driving assistance device having the improved structure previously described, the traffic sign detection section detects such a ramp sign including an exit symbol and its speed limit symbol on the basis of the front image data captured by the in-vehicle camera. The exit symbol calls the attention of the driver of the own vehicle to leave the current driving lane on the vehicle roadway such as a highway on which the own vehicle travels, and enter the ramp lane connected to the driving lane. Further, the distance detection section detects the distance in a width direction of the vehicle roadway between the own vehicle and the ramp sign. Further, the driver's intention detection section detects the driver's intention to change the current driving lane. Furthermore, the lane entry detection section detects that the own vehicle enters the ramp lane when the distance detected by the distance detection section is smaller than the predetermined distance and the direction to change the current driving lane of the own vehicle detected by the driver's intention detection section is equal to the direction designated by the exit symbol in the ramp sign.

In general, a ramp sign has an exit symbol and a speed limit symbol in a ramp lane, and a plurality of the ramp signs are arranged along the ramp lane. The first ramp sign is installed at an entrance of the ramp lane. On the other hand, there is no ramp sign at an entrance of general roadways. Accordingly, it is possible for the driving assistance device to recognize a ramp lane as a connection lane through which the own vehicle leaves the highway when detecting the presence of the ramp sign having a combination of the exit symbol and the speed limit symbol. In particular, it is possible for the driving assistance device to judge, i.e. correctly recognize that the own vehicle is now running on the driving lane close to the ramp lane when detecting such a ramp sign containing the exit symbol and the speed limit symbol and the distance in a width direction between the lamp sign and the own vehicle is smaller than the predetermined distance. Further, when there is the driver's intention to change the travel direction of the own vehicle toward the direction of the ramp sign, the driving assistance device can judge that the travel direction of the own vehicle on the driving lane is changed toward the direction of the ramp lane Wr (see FIG. 2) located close to the travel lane Wh1 (see FIG. 2). Accordingly, it is possible for the driving assistance device to correctly detect entry of the own vehicle into the connection lane such as the ramp lane Wr without causing an incorrect detection of the driving lane change on the multiple lanes on the highway.

### BRIEF DESCRIPTION OF THE DRAWINGS

A preferred, non-limiting embodiment of the present invention will be described by way of example with reference to the accompanying drawings, in which:

FIG. 1 is a view showing a schematic structure of an ECU 20 as a driving assistance device 20d various detection devices and sensors mounted on an own vehicle 50 according to an exemplary embodiment of the present invention;

FIG. 2 is a view showing a high way having multiple lanes Wh1, Wh2 and Wh3 and a ramp lane Wr, on which the own vehicle 50 travels, and showing three ramp signs Sg installed and arranged along the ramp lane Wr branched from a driving lane Wh1 on the highway;

FIG. 3 is a view showing a ramp sign Sg displayed on a display unit 31 mounted on the own vehicle 50 when the own vehicle 50 is running on the ramp lane Wr; and

FIG. 4 is a flow chart showing the process of detecting entry of the own vehicle 50 into the ramp lane Wr on the highway when the own vehicle 50 enters the ramp lane Wr, and notifying to the driver of the own vehicle 50 the occurrence of entry of the own vehicle 50 into the ramp lane Wr.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### Exemplary Embodiment

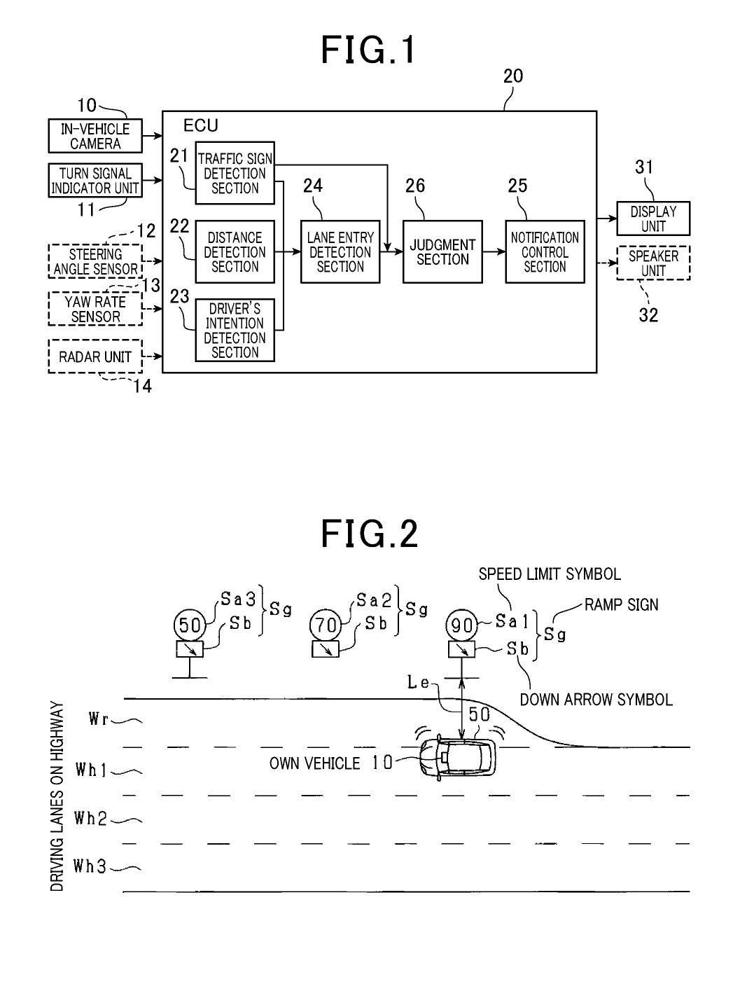

A description will be given of a driving assistance device 20 according to an exemplary embodiment with reference to FIG. 1 to FIG. 4.

The driving assistance device 20 according to the exemplary embodiment is mounted on a motor vehicle (hereinafter, the own vehicle 50). The driving assistance device 20 shown in FIG. 1 detects when the own vehicle 50 enters a connection lane, i.e. a ramp lane Wr (See FIG. 2) connected to a current driving lane Wh1 on a vehicle roadway such as a highway or a freeway on which the own vehicle 50 is running. The driving assistance device 20 performs driving assistance for the own vehicle 50.

In the following description, the driving assistance device 20 performs the driving assist when the own vehicle 50 is running on the current driving lane on the highway, and enters a ramp lane connected to the current driving lane on the highway. As shown in FIG. 2, the ramp lane Wr is arranged at the most right side of the highway.

It is also possible to apply the driving assistance device 20 according to the exemplary embodiment to vehicles used in various countries having different traffic rules. For example, the driving assistance device 20 according to the exemplary embodiment can perform the driving assist when a vehicle enters a ramp lane arranged at a left side of a highway.

A description will now be given of a schematic structure of the driving assistance device 20 according to the exemplary embodiment with reference to FIG. 1.

FIG. 1 is a view showing a schematic structure of the driving assistance device 20, various detection devices and sensors mounted on an own vehicle 50 according to the exemplary embodiment. As shown in FIG. 1, the driving assistance device 20 according to the exemplary embodiment is an electronic control device (hereinafter, the ECU 20). One or more in-vehicle cameras 10 capture images around the own vehicle 50, and transmit image information regarding the captured image data to the ECU 20. A turn signal indicator unit 11 lights and transmits a turn signal to the ECU 20. The ECU 20 receives the image information transmitted from the in-vehicle camera 10 and the turn signal transmitted from the turn signal indicator unit 11. The ECU 20 generates and transmits driving information regarding the ramp lane to a display unit 31.

The in-vehicle camera 10 is a monocular camera or a stereo camera composed of a charge coupled device (CCD) image sensor, a complementary metal oxide semiconductor (CMOS) image sensor, a near infrared rays sensor, etc. For example, the in-vehicle camera 10 is mounted at an upper side of a windshield (or a wind screen) of the own vehicle 50. The in-vehicle camera 10 captures front images within a predetermined angle range in front of the own vehicle 50, and sequentially transmits captured front image data to the ECU 20.

The driver of the own vehicle 50 operates the turn signal indicator unit 11 to indicate the direction of turning right or left of the own vehicle 50. The turn signal indicator unit 11 transmits a turning instruction signal to the ECU 20.

The ECU 20 is composed of a central processing unit (CPU), a read only memory (ROM), a random access memory (RAM), an input output interface (I/O interface), etc. The ROM stores various control programs in advance. The ECU 20 executes the programs stored in the ROM. The execution of the programs realizes the functions of a traffic sign detection section 21, a distance detection section 22, a driver's intention detection section 23, a lane entry detection section 24, a notification control section 25 and a judgment section 26.

The traffic sign detection section 21 detects a ramp sign Sg on the basis of the front image data captured by and transmitted from the in-vehicle camera 10. The ramp sign Sg provides an indication of a place where the vehicle may leave the drive lane Wh1 on the highway, and enter the ramp lane Wr. (see FIG. 2). That is, the ramp lane Wr is located between the highway and the general road.

Such a ramp sign Sg is one of highway signs, and used as a leaving sign for leaving a current driving lane and entering a ramp lane. The ramp sign Sg also contains a ramp speed sign Sa1, Sa2, or Sa3 (see FIG. 2) which indicates a speed limit.

FIG. 2 is a view showing the high way having the multiple lanes Wh1, Wh2 and Wh3 and the ramp lane Wr, on which the own vehicle 50 travels. FIG. 2 also shows the three ramp signs Sg installed and arranged along the ramp lane Wr branched from the driving lane Wh1 on the highway. That is, FIG. 2 shows an example of right-side traveling on a highway, for example in Europe. The highway has three driving lanes Wh1, Wh2 and Wh3 on each side. As shown in FIG. 2, the ramp lane Wr is arranged at the most right side of the highway.

The ramp lane Wr is arranged close to the driving lane Wh1 which is located at the right side in the forward direction of the own vehicle 50. FIG. 2 shows the three ramp signs Sg located at the right side of the ramp lane Wr which leaves the highway. In general, a ramp sign Sg is not located on a driving lane Wh1, Wh2, Wh3 of the highway and also on a general road. For this reason, when detecting a ramp sign Sg, the ECU 20 as the driving assistance device can detect the presence of the ramp lane Wr. Although FIG. 2 shows the three ramp signs Sg installed at the right side of the ramp lane Wr in the forward direction of the own vehicle 50.

When the own vehicle 50 travels on the ramp lane Wr, the actual ramp signs Sg are located to face the own vehicle 50 which is running on the ramp lane Wr so that the driver of the own vehicle 50 recognizes the ramp signs Sg in front of the own vehicle 50.

As shown in FIG. 2, for example, a ramp sign Sg in Europe includes a ramp speed limit symbol Sal, Sat or Sa3 and an auxiliary symbol Sb. The auxiliary symbol Sb is a down arrow symbol such as an exit symbol and a leaving sign. Each of the speed limit symbols Sa1, Sa2 and Sa3 indicates a speed limit. The auxiliary symbol Sb indicates a lower right direction when the driver of the own vehicle 50 views it from the front side. Accordingly, when the own vehicle 50 goes to the right side on the basis of the auxiliary symbol Sb of the ramp sign Sg, the own vehicle 50 can leave the highway.

The traffic sign detection section 21 in the ECU 20 performs known pattern matching process by using the front image data transmitted from the in-vehicle camera 10, and detects the presence of the ramp sign Sg.

Various countries use a different exit symbol in the ramp sign Sg to show a place to leave the highway. For example, Japan uses a ramp sign Sg with “EXIT” to leave a highway. The traffic sign detection section 21 performs pattern matching of front image data captured by the in-vehicle camera 10 by using pattern data which correspond to predetermined country or various countries in which the own vehicle travels. The traffic sign detection section 21 detects a ramp sign Sg on the basis of the results of the pattern matching and the front image data. FIG. 2 shows the three ramp signs Sg, i.e. the ramp sign Sg with the ramp speed limit of 90 km, the ramp sign Sg with the ramp speed limit of 70 km, and the ramp sign Sg with the ramp speed limit of 50 km. In general, the number of the ramp signs Sg is changed on the basis of a distance of the ramp lane Wr, etc.

The distance detection section 22 detects a distance Le in a width direction of the highway between the own vehicle 50 and the ramp sign Sg detected by the traffic sign detection section 21. In more detail, the distance detection section 22 detects the distance Le between the side surface of the own vehicle 50 and the ramp sign Sg on the basis of the front image data captured by the in-vehicle camera 10. It is also acceptable to use another distance between the ramp sign Sg and the center of the own vehicle in a width direction of the driving lanes on the highway, or between the ramp sign Sg and the side surface of the own vehicle 50 on the current driving lane.

The driver's intention detection section 23 detects a driver's intention for the own vehicle 50 to change the current driving lane on the highway on which the own vehicle 50 travels. In more detail, the driver's intention detection section 23 detects the driver's intention for the own vehicle 50, i.e., whether or not the driver of the own vehicle 50 intention for change the driving lane on the highway and a change direction on the basis of the turning instruction signal transmitted from the turn signal indicator unit 11.

The lane entry detection section 24 detects entry of the own vehicle 50 into the ramp lane Wr as the connection lane. In more detail, the lane entry detection section 24 detects that the own vehicle 50 has entered the ramp lane Wr when the following four conditions (1) to (4) are satisfied:
(1) the traffic sign detection section 21 has detected the presence of the ramp sign Sg;
(2) the distance Le detected by the distance detection section 22 is smaller than a predetermined distance Y (m);
(3) the driver's intention detection section 23 has detected the driver's intention to change the travel direction of the own vehicle 50 to the ramp sign Sg corresponding to the forward direction of the own vehicle 50; and
(4) the speed of the own vehicle 50 which has entered the ramp lane Wr is greater than a predetermined speed limit X.

The predetermined distance Y (m) used in the condition (2) has been determined on the basis of the road width of the driving lane and the road width of the ramp lane on the highway on which the own vehicle 50 travels. In more detail, the predetermined distance Y (m) used in the condition (2) is determined on the basis of the lane width of the driving lane on the highway adjacent to the ramp lane Wr, and a distance between a lane shoulder of the outermost driving lane on the highway and the ramp sign Sg. For example, the predetermined distance Y (m) used in the condition (2) is approximately 7 m which is a total distance of:

the lane width of the driving lane Wh1 (see FIG. 2) which is adjacent to the ramp lane Wr; and

the lane width of the ramp lane Wr.

In general, the following lane widths have been determined in advance:

the lane width of a driving lane of a highway;

the distance between the outer lane shoulder of the driving lane Wh1 and the ramp sign Sg; and

the lane width of the ramp lane Wr.

When the condition (2) is satisfied, the own vehicle 50 is running on the driving lane close to the ramp lane Wr. That is, the satisfaction of the condition (2) allows the ECU 20 as the driving assistance device to eliminate the detection when moving to the ramp lane WR from each of the driving lanes Wh2 and Wh3. That is, the satisfaction of the condition (2) can avoid an incorrect detection of the lane change from the driving lane Wh2 to the driving lane Wh1, or from the driving lane Wh3 to the driving lane Wh2, as the entry of the own vehicle 50 to the ramp lane Wr.

The condition (3) detects whether or not the own vehicle 50 drives according to the instruction of the ramp signs Sg. As shown in FIG. 2, when the own vehicle 50 changes the current driving lane Wh1 toward the right side direction, it is detected for the own vehicle 50 to leave the current driving lane Wh1 and enter the ramp lane Wr on the basis of the instruction of the ramp signs Sg. In this case, the own vehicle 50 travels on the basis of the speed limit symbol Sa1 in the ramp sign Sg.

On the other hand, as shown in FIG. 2, when the own vehicle 50 changes the current driving lane Wh1 toward the left side direction, for example, into the driving lane Wh2, the own vehicle 50 drives without following the speed limit in the ramp sign Sg. In the latter case, the own vehicle 50 can drive without using the speed limit symbol Sa1 of the ramp sign Sg.

Because the ramp signs Sg are located on the ramp lane Wr, the ramp signs Sg are installed in the installation direction of each of the ramp signs Sg to the forward direction of the own vehicle 50. Further, as shown in FIG. 2, when the ramp sign Wg contains an arrow mark, it is possible to judge that the direction designated by the arrow mark indicates the exit direction.

Because the ramp signs Sg are located on the ramp lane Wr, the ramp signs Sg are installed in the installation direction of each of the ramp signs Sg to the forward direction of the own vehicle 50. Further, as shown in FIG. 2, when the ramp sign Sg contains an arrow mark as the exit mark, and the exit mark of the ramp sign Sg shows the direction of the ramp lane Wr, it is acceptable to detect whether or not the travel change direction of the own vehicle 50 is equal to the direction designated by the exit direction of the ramp sign Sg.

The predetermined speed limit of the condition (4) is used to suppress an incorrect detection of entering the ramp lane Wr when the own vehicle 50 travels on a general road, not on a highway.

In general, the ramp sign Sg is not installed on general roads other than highways. However, the conventional driving assistance device causes an incorrect detection of a traffic sign as a ramp sign when the own vehicle 50 travels on a general road, not on a ramp lane.

The use of the condition (4) suppresses such an incorrect detection of the ECU 20 as the driving assistance device so that the own vehicle 50 enters the ramp lane Wr or a ramp road. For example, the predetermined speed X is determined on the basis of a speed limit used for the driving lanes Wh1, Wh2, Wh3 on the highway.

For example, when all of the conditions (1) to (4) are satisfied, the lane entry detection section 24 detects that the own vehicle 50 has entered the ramp lane Wr and travels on the ramp lane Wr. The concept of the present invention is not limited by this. For example, it is also possible to detect entry of the own vehicle 50 into the ramp lane Wr when the conditions (1) to (3) are satisfied.

The judgment section 26 detects a section of the ramp lane Wr on which the own vehicle 50 travels when the lane entry detection section 24 detects that the own vehicle 50 has entered the ramp lane Wr. The section of the ramp lane Wr is from the entrance place of the ramp lane Wr to the exit place of the ramp lane Wr.

In more detail, the judgment section 26 judges the section of the ramp lane Wr when the ramp signs Sg detected by the traffic sign detection section 21 are arranged in the forward direction of the own vehicle 50. Usually, the front image data captured by the in-vehicle camera 10 contain a plurality of the ramp signs Sg when the own vehicle 50 travels on the ramp lane Wr. The judgment section 26 can judge the presence of the ramp lane Wr on the basis of one or more successive front image data items.

In general, as shown in FIG. 2, a plurality of the ramp signs Sg are arranged at predetermined intervals along the ramp lane Wr, i.e. from the entrance of the ramp lane to the exit lane. The predetermined intervals are narrow than those installed on a driving lane on a highway or a general road.

Furthermore, in general, each of the ramp signs Sg arranged along the lane shoulder of the ramp lane Wr has a different speed limit symbol, and the value of the speed limit is gradually reduced from the entrance to the exit of the ramp lane Wr.

The notification control section 25 notifies, to the driver of the own vehicle 50 through the display unit 31 and/or the speaker 32 shown in FIG. 1, the information that the own vehicle 50 is now running on the section of the ramp lane Wr and the information regarding the speed limit. This speed limit corresponds to the current location of the own vehicle 50 on the basis of the information of the speed limit symbol in the ramp signs Sg.

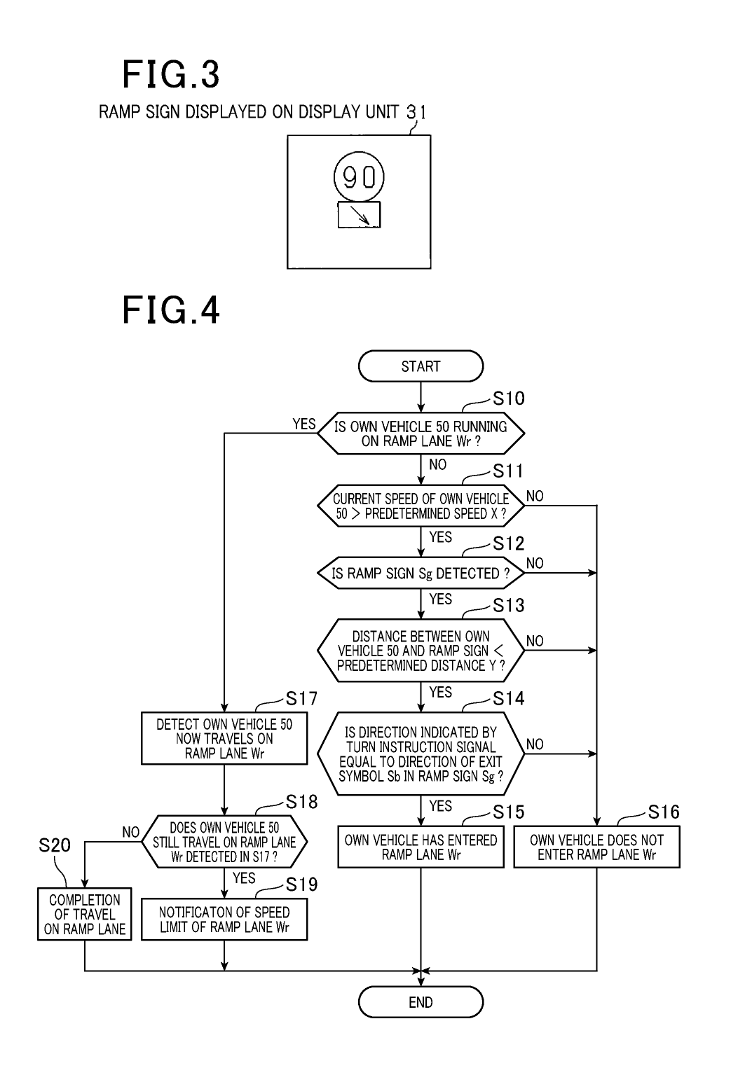

FIG. 3 is a view showing a ramp lane sign Sg displayed on the display unit 31 mounted on the own vehicle 50 when the own vehicle 50 is running on the ramp lane Wr of the highway.

As shown in FIG. 3, the notification control section 25 transmits to the display unit 31 the information of the speed limit symbol Sa1 of 90 km and a down arrow symbol as the auxiliary symbol Sb (see FIG. 2). When receiving the information, the display unit 31 displays the information of the speed limit symbol Sa1 of 90 km and the down arrow symbol. The driver of the own vehicle 50 recognizes that the own vehicle 50 is now running on the ramp lane Wr and the speed limit symbol Sa1 is 90 km.

In the case shown in FIG. 2, the notification control section 25 transmits the information of the ramp signs Sg containing the speed limit symbol and the down arrow symbol as the auxiliary symbol Sb to the display unit 31 during the period counted from the time when the own vehicle 50 enters the ramp lane Wr to the time when the own vehicle 50 has passed through the ramp sign Sg including the speed limit symbol Sat of 70 km.

The notification control section 25 further transmits to the display unit 31 the information of the speed limit symbol and the down arrow symbol as the auxiliary symbol Sb during the period counted from the time when the own vehicle 50 has passed through the ramp sign Sg including the speed limit symbol Sat of 70 km to the time when the own vehicle 50 has passed through the ramp sign Sg including the speed limit symbol Sa3 of 50 km. The display unit 31 continues to display the received information.

After this, the notification control section 25 transmits to the display unit 31 the information of the speed limit symbol Sa3 and the auxiliary symbol (the down arrow symbol) Sb of the ramp sign Sg. The display unit 31 displays the information of the ramp sign Sg with the speed limit symbol Sa3 and the auxiliary symbol (the down arrow symbol) Sb.

There is a possible case in which the driver of the own vehicle 50 does not reduce the speed of the own vehicle 50 on the ramp lane Wr even if the own vehicle 50 has left the highway, i.e. has entered the ramp lane Wr from the driving lane Wh1 on the highway. As previously described, the ECU 20 as the driving assistance device according to the exemplary embodiment provides the information regarding the entry of the ramp lane Wr and the speed limit to the driver of the own vehicle 50 through the display unit 31 in order for the driver of the own vehicle 50 to reduce the current speed of the own vehicle 50. Accordingly, it is possible for the ECU 20 as the driving assistance device to perform the correct driving assist to call the attention of the driver of the own vehicle 50 to reduce the current speed of the own vehicle 50 to a vehicle speed within an allowable speed range regarding the speed limit of the ramp lane Wr. The driving assistance device according to the exemplary embodiment provides the safe driving suitable for the ramp lane Wr.

The display unit 31 (as the notification device) is a meter display arranged on a vehicle instrument panel, for example. The display unit 31 is composed of a liquid crystal display, etc. When the own vehicle 50 has a car navigation device, it is possible to use the car navigation device as the display unit 31.

A description will now be given of the process of detecting and notifying entry of the own vehicle 50 to the ramp lane Wr and notifying this to the driver of the own vehicle 50 with reference to FIG. 4.

FIG. 4 is a flow chart showing the process of detecting entry of the own vehicle 50 into the ramp lane Wr on the highway when the own vehicle 50 enters the ramp lane Wr, and notifying to the driver of the own vehicle 50 the occurrence of entry of the own vehicle 50 into the ramp lane Wr.

The ECU 20 as the driving assistance device according to the exemplary embodiment repeatedly performs the process shown in FIG. 4 every time when receiving the front image data captured by and transmitted from in-vehicle camera 10.

In step S10, the ECU 20 judges whether or not the own vehicle 50 is now running on the ramp lane Wr. That is, after the judgment to enter the ramp lane Wr, the ECU 20 judges whether or not the own vehicle 50 has left the ramp lane Wr.

When the detection result in step S10 indicates negation (“NO” in step S10), the operation flow progresses to step S11.

In step S11, the ECU 20 further judges whether or not the current speed of the own vehicle 50 is higher than the predetermined speed X. That is, it is judged whether or not the condition (4) is satisfied. When the result of the judgment in step S11 indicates negation (“NO” in step S11), i.e. that the current speed of the own vehicle 50 is lower than the predetermined speed X, the operation flow progresses to step S16.

In step S16, the ECU 20 judges that the own vehicle 50 does not enter the ramp lane Wr, and completes the process shown in FIG. 4.

On the other hand, the result of the judgment in step S11 indicates affirmation (“YES” in step S11), i.e. the current speed of the own vehicle 50 is higher than the predetermined speed X, the operation flow progresses to step S12.

In step S12, the ECU 20 judges whether or not the ramp sign Sg has been detected. That is, in step S12, the ECU 20 judges whether or not the condition (1) is satisfied. When the result of the judgment in step S12 indicates negation (“NO” in step S12), i.e. the ramp sign Sg is not detected, the operation flow progresses to step S16. In step S16, the ECU 20 judges that the own vehicle 50 has not entered the ramp lane Wr, and completes the process shown in FIG. 4.

When the result of the judgment in step S12 indicates affirmation (“YES” in step S12), i.e. the ramp sign Sg has been detected, the operation flow progresses to step S13.

In step S13, the ECU 20 judges whether or not the distance Le between the ramp sign Sg and the own vehicle 50 is smaller than the predetermined distance Y (m). That is, the ECU 20 judges whether or not the condition (2) is satisfied.

When the result of the judgment indicates negation (“NO” in step S13), i.e. the distance Le between the ramp sign Sg and the own vehicle 50 is not less than the predetermined distance Y (m), the operation flow progresses to step S16.

In step S16, the ECU 20 judges that the own vehicle 50 does not enter the ramp lane Wr, and completes the process shown in FIG. 4.

On the other hand, when the result of the judgment in step S13 indicates affirmation (“YES” in step S13), i.e. the distance Le is smaller than that of the predetermined distance Y(m), the operation flow progresses to step S14.

In step S14, the ECU 20 judges whether or not the installation direction of the ramp signs Sg in the forward direction of the own vehicle 50 is equal to the direction indicated by the turning instruction signal transmitted from the turn signal indicator unit 11. That is, the ECU 20 judges whether or not the condition (3) is satisfied.

When the result of the judgment indicates negation (“NO” in step S14), i.e. the installation direction of the ramp signs Sg in the forward direction of the own vehicle 50 is different from the direction indicated by the turning instruction signal, the operation flow progresses to step S16.

In step S16, the ECU 20 judges that the own vehicle 50 does not enter the ramp lane Wr, and completes the process shown in FIG. 4.

On the other hand, when the result of the judgment indicates affirmation (“YES” in step S14), i.e. the installation direction of the ramp signs Sg in the forward direction of the own vehicle 50 is equal to the direction indicated by the turning instruction signal, the operation flow progresses to step S15.

In step S15, the ECU 20 judges that the own vehicle 50 has entered the ramp lane Wr. The ECU 20 completes the process shown in FIG. 4.

When the result of the judgment in step S10 indicates affirmation (“YES” in step S10), i.e. that the own vehicle 50 now travels on the ramp lane Wr after the entry of the own vehicle 50 into the ramp lane Wr, the operation flow progresses to step S17.

In step S17, the ECU 20 detects the section of the ramp lane Wr when the own vehicle 50 has entered into the ramp lane Wr detected in step S15 and the own vehicle 50 has not already passed through the end place of the ramp lane Wr, i.e. the own vehicle is now running on the ramp lane Wr. The operation flow progresses to step S18.

In step S18, the ECU 20 detects whether or not the own vehicle 50 still travels on the section of the ramp lane Wr detected in step S17. When the result of the judgment in step S18 indicates affirmation (“YES” in step S18), i.e. the own vehicle 50 is now running on the section of the ramp lane Wr detected in step S17, the ECU 20 instructs the display unit 31 to display the speed limit at the current location of the own vehicle 50. The driver of the own vehicle 50 recognizes the speed limit at the current location of the own vehicle 50 displayed on the display unit 31.

On the other hand, when the result of the judgment in step S18 indicates negation (“NO” in step S18), i.e. the own vehicle 50 has left the ramp lane Wr detected in step S17, the operation flow progresses to step S20.

In step S20, the ECU 20 judges that the own vehicle 50 has already left the ramp lane Wr. The ECU 20 completes the process shown in FIG. 4.

The ECU 20 as the driving assistance device according to the exemplary embodiment has the following effects.

In general, on a highway, a ramp sign is installed at the entrance of a ramp lane Wr. The ramp sign is a combination of an exit symbol designated by a down arrow symbol and a speed limit symbol in the ramp lane. The presence of such an exit symbol calls the attention of the driver of the own vehicle 50 to leave the highway. On the other hand, general roads have no such a ramp sign. The driving assistance device can recognize the presence of a ramp lane in front of the own vehicle 50 in a forward direction of the own vehicle 50 when detecting a ramp sign, i.e. a combination of an exit symbol and a speed limit symbol.

In particular, when detecting such a ramp sign Sg which is a combination of a speed limit symbol and an exit symbol, and the distance Le between the lamp sign Sg and the own vehicle 50 is smaller than the predetermined distance Y, the ECU 20 as the driving assistance device judges, i.e. correctly recognizes that the own vehicle 50 is now running on the driving lane Wh1 close to the ramp lane Wr. Further, when there is a driver's intention for the own vehicle 50 to change the travel direction toward the direction of the ramp sign Sg, the ECU 20 as the driving assistance device can judge that the travel direction of the own vehicle 50 is changed from the driving lane Wh1 toward the direction of the ramp lane Wr which is located adjacent to the travel lane Wh1.

As set forth, when the conditions (1), (2) and (3) are satisfied, the ECU 20 as the driving assistance device according to the exemplary embodiment performs a correct detection for the own vehicle 50 to enter the ramp lane Wr without causing an incorrect detection of a driving lane change on a highway having multiple lanes. In general, a plurality of ramp signs Sg are installed in a forward direction of the own vehicle 50 at a lane shoulder of a lamp lane Wr which is connected to a driving lane on a highway, through which the own vehicle 50 can leave the highway. After detecting entry of the own vehicle 50 into the ramp lane Wr, the ECU 20 as the driving assistance device judges that the section on which a plurality of detected ramp signs are arranged in the forward direction of the own vehicle 50 is the ramp lane Wr.

Further, during the travel of the own vehicle 50 on the section of the ramp lane Wr, the ECU 20 as the driving assistance device notifies to the driver of the own vehicle 50 through the display unit 31 the information that the own vehicle 50 is now running on the section of the ramp lane Wr and the speed limit. This notification makes it possible to indicate to the driver of the own vehicle 50 that the own vehicle 50 is now running on the ramp lane Wr and the current vehicle speed of the own vehicle 50 is maintained within the allowable speed range indicated by the speed limit symbol Sb in the ramp sign Sg. This control makes it possible to provide the safe driving on the ramp lane Wr.

When the condition (4) is satisfied in addition to the satisfaction of the conditions (1), (2) and (3), the ECU 20 also judges that the own vehicle 50 has entered the ramp lane Wr. This also makes it possible to avoid an incorrect detection when the own vehicle 50 travels on a general road.

The ECU 20 as the driving assistance device uses the predetermined distance Y which is determined in advance on the basis of the lane width of the driving lane Wh1 of the highway and the ramp lane width of the ramp lane Wr. This makes it possible to suppress occurrence of an incorrect detection of the entry of the own vehicle 50 into the ramp lane Wr instead of detecting a lane change from a current driving lane, on which the own vehicle 50 is now running, to another driving lane (for example, the lane change to the driving lane Wh1 from the driving lane Wh2) on a highway.

The ECU 20 as the driving assistance device can detect the driver's intention for the own vehicle 50 to change the lane change on the basis of the turning instruction signal transmitted from the turn signal indicator unit 11.

### Various Modifications

The concept of the driving assistance device and the ECU 20 as the driving assist method according to the present invention is not limited by the exemplary embodiment previously described. For example, the following modifications are also acceptable.

It is possible to perform the drive power control of the own vehicle 50 on the basis of the detection results regarding entry of the own vehicle into the ramp lane and the detected section of the ramp lane Wr. It is acceptable for the ECU 20 as the driving assistance device to perform a shift down control of the driving assist when detecting entry of the own vehicle 50 into the ramp lane Wr.

It is acceptable for the ECU 20 as the driving assistance device to judge that the own vehicle 50 has entered the ramp lane Wr when the conditions (1), (2) and (3) are satisfied and the condition (4) is not satisfied. In this modification, it is possible to eliminate Step S11 shown in FIG. 4. This modification would cause a possible incorrect detection regarding the entry of the own vehicle 50 into the ramp lane Wr when compared with a case of satisfying all of the conditions (1) to (4). However, this modification can also detect entry of the own vehicle 50 into the ramp lane Wr.

It is acceptable for the driver's intention detection section 23 in the ECU 20 as the driving assistance device to detect the driver's intention for the own vehicle 50 to change the current drive lane on the basis of a steering angle direction of the own vehicle 50 when a steering angle sensor 12 designated by a dotted line shown in FIG. 1 detects a steering angle and the ECU 20 receives a steering angle signal transmitted from the steering angle sensor 12.

Further, it is also acceptable for the driver's intention detection section 23 in the ECU 20 as the driving assistance device to detect the driver's intention for the own vehicle 50 to change the current drive lane on the basis of a yaw rate signal when the yaw rate sensor detects a yaw rate of the own vehicle 50 and the ECU 20 receives the yaw rate signal transmitted from the yaw rate sensor 13.

Still further, it is sufficient for the driver's intention detection section 23 to detect the driver's intention for the own vehicle 50 to change the current drive lane on the basis of at least one of the turning instruction signal transmitted from the turn signal indicator unit 11, the steering angle signal transmitted from the steering angle sensor 12, and the yaw rate signal transmitted from the yaw rate sensor 13.

When the own vehicle 50 has a radar unit 14 such as a millimeter-wave radar device designated by a dotted line shown in FIG. 1, it is possible to measure the distance in a width direction between the own vehicle 50 and the ramp lane Sg on the basis of distance information obtained by the radar unit 14. In this case, it is possible for the distance detection section 22 to calculate the distance Le between the own vehicle 50 and the ramp sign Wg on the basis of the distance information transmitted from the radar unit 14.

When the own vehicle 50 has a speaker unit 32 designated by a dotted line shown in FIG. 1, it is possible for the notification control section 25 to notify to the driver of the own vehicle 50 through the speaker unit 32 that the own vehicle 50 is now running on a ramp lane and the information regarding the speed limit of the ramp lane. It is also acceptable for the notification control section 25 to notify these information to the driver of the own vehicle 50 through the display unit 31 and the speaker unit 32. It is also acceptable for the notification control section 25 to notify these information to the driver of the own vehicle 50 through at least one of the display unit 31 and the speaker unit 32.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A driving assistance device comprising:
a traffic sign detection section capable of detecting a ramp sign including an exit symbol and a speed limit symbol on a basis of front image data captured by an in-vehicle camera mounted on an own vehicle, the exit symbol calling attention of the driver of the own vehicle to leave a driving lane on a vehicle roadway, and enter a connection lane connected to the driving lane;
a distance detection section capable of detecting a distance in a width direction of the vehicle roadway between the own vehicle and the ramp sign detected by the traffic sign detection section;
a driver's intention detection section capable of detecting the intention of the driver of the own vehicle to change a current driving lane of the own vehicle; and
a lane entry detection section capable of detecting that the own vehicle enters the connection lane when the distance detected by the distance detection section is smaller than a predetermined distance, and a direction to change the current driving lane of the own vehicle detected by the driver's intention detection section is equal to a direction designated by the exit symbol of the ramp sign.

2. The driving assistance device according to claim 1, further comprising:
a judgment section capable of judging that the detected driving lane is the connection lane when a plurality of the ramp signs are arranged on the detected driving lane in forward direction of the own vehicle after the lane entry detection section detects that the own vehicle has entered the connection lane; and
a notification control section capable of notifying, to the driver of the own vehicle through a notifying unit, a speed limit indicated by the speed limit symbol of the ramp sign located at a current location of the own vehicle on the connection lane when the lane entry detection section detects that the own vehicle has entered the connection lane, and the judgment section judges that the own vehicle is running on the connection lane.

3. The driving assistance device according to claim 1, wherein
the lane entry detection section detects entry of the own vehicle into the connection lane when a current vehicle speed of the own vehicle is higher than a predetermined speed.

4. The driving assistance device according to claim 2, wherein
the lane entry detection section detects entry of the own vehicle into the connection lane when a current vehicle speed of the own vehicle is higher than a predetermined speed.

5. The driving assistance device according to claim 1, wherein the predetermined distance is determined on a basis of a lane width of the driving lane adjacent to the connection lane and a lane width of the connection lane.

6. The driving assistance device according to claim 2, wherein the predetermined distance is determined on a basis of a lane width of the driving lane adjacent to the connection lane and a lane width of the connection lane.

7. The driving assistance device according to claim 3, wherein the predetermined distance is determined on a basis of a lane width of the driving lane adjacent to the connection lane and a lane width of the connection lane.

8. The driving assistance device according to claim 4, wherein the predetermined distance is determined on a basis of a lane width of the driving lane adjacent to the connection lane and a lane width of the connection lane.

9. The driving assistance device according to claim 1, wherein the driver's intention detection section detects the driver's intention for the own vehicle to change a current driving lane of the own vehicle on a basis of at least one of a turning instruction signal transmitted from a turn signal indicator unit of the own vehicle, a steering angle signal transmitted from a steering angle sensor of the own vehicle, and a yaw rate signal transmitted from a yaw rate sensor of the own vehicle.

10. The driving assistance device according to claim 2, wherein the driver's intention detection section detects the driver's intention for the own vehicle to change a current driving lane of the own vehicle on a basis of at least one of a turning instruction signal transmitted from a turn signal indicator unit of the own vehicle, a steering angle signal transmitted from a steering angle sensor of the own vehicle, and a yaw rate signal transmitted from a yaw rate sensor of the own vehicle.

11. The driving assistance device according to claim 3, wherein the driver's intention detection section detects the driver's intention for the own vehicle to change a current driving lane of the own vehicle on a basis of at least one of a turning instruction signal transmitted from a turn signal indicator unit of the own vehicle, a steering angle signal transmitted from a steering angle sensor of the own vehicle, and a yaw rate signal transmitted from a yaw rate sensor of the own vehicle.

12. The driving assistance device according to claim 4, wherein the driver's intention detection section detects the driver's intention for the own vehicle to change a current driving lane of the own vehicle on a basis of at least one of a turning instruction signal transmitted from a turn signal indicator unit of the own vehicle, a steering angle signal transmitted from a steering angle sensor of the own vehicle, and a yaw rate signal transmitted from a yaw rate sensor of the own vehicle.

13. A driving assistance method performed by a driving assistance device mounted on an own vehicle, comprising steps of:
detecting a ramp sign including an exit symbol and a speed limit symbol on a basis of front image data captured by an in-vehicle camera mounted on the own vehicle, the exit symbol indicating to a driver of the own vehicle a location of a connection lane to leave a driving lane on a vehicle roadway, and enter a connection lane connected to the driving lane;
detecting a distance in a width direction of the vehicle roadway between the own vehicle and the ramp sign detected by the traffic sign detection section;
detecting driver's intention for the own vehicle to change a current driving lane of the own vehicle; and
detecting that the own vehicle enters the connection lane when the distance detected by the distance detection section is smaller than a predetermined distance, and a direction to change the current driving lane of the own vehicle detected by the driver's intention detection section is equal to a direction designated by the exit symbol of the ramp sign.
